(19) United States
(12) Patent Application Publication
(10) Pub. No.: US 2012/0085587 A1
(43) Pub. Date: Apr. 12, 2012

(54) Wind Power for Electric Cars

(76) Inventor: David Drouin, Tilton, NH (US)

(21) Appl. No.: 13/084,769

(22) Filed: Apr. 12, 2011

Related U.S. Application Data
(60) Provisional application No. 61/390,827, filed on Oct. 7, 2010.

(51) Int. Cl. B60L 8/00

(52) U.S. Cl. 180/2.2

(57) ABSTRACT

A modular wind turbine device mountable in a plurality of locations along the exterior of a vehicle. The device comprises a low profile air inlet, a rotatable turbine that utilizes incoming air flow for motive power, and an alternator device for transforming the rotation of the turbine into usable electric power. The air inlet is a raised air scoop that protrudes from the external surface of the vehicle, similar to forced air induction inlets or brake cooling inlets on current vehicles. The inlet is shrouded with a mesh screen to prevent discrete objects from entering or interfering with the turbine device. The turbine is an elongated cylinder with protruding fins that utilize the pressure of the incoming air flow to spin about its central axis. A side-mounted alternator provides a core that spins within a stator to produce an electric current. The electric current is fed to a power management system for controlling and powering a battery pack. The device is ideal for offsetting electric power usage in electric cars by utilizing the overflowing air pressure to induce mechanical motion and create an onboard power generation source.

### CROSS REFERENCE TO RELATED APPLICATION

This application claims the benefit of U.S. Provisional Application No. 61/390,827 filed on Oct. 7, 2010, entitled “Wind Power for Electric Cars”

### BACKGROUND OF THE INVENTION

1. Field of the Invention

The present invention relates to wind power devices for automobiles. More specifically, the present invention relates to a low profile, wind turbine generator for offsetting electrical power usage in an electric car.

2. Description of the Prior Art

Electric cars are quickly becoming a viable replacement for the internal combustion powered vehicles currently on the market, which have dominated the 20^{th} century as the primary power source for automobiles in the United States. Electric cars are capable of transforming electric power into mechanical motion to power the wheels of a large automobile, eliminating the need for an external fuel such as gasoline or diesel fuel. Dependence on foreign sources of fuel and the harmful effects on the environment have started a shift toward purely electric vehicles.

The power from an electric car is typically delivered using a series of batteries and one or more high output electric motors. Power is derived from grid A/C power, which requires the user to park and plug in the car to an electrical outlet for extended periods of time while the onboard batteries recharge. Drainage of power in these vehicles is a limiting factor, as the distance traveled between recharging is limited to the supply of electric power from the batteries. A common problem with electric cars is range anxiety, in which consumers are reluctant to purchase vehicle that can only travel a short distance from a power source before requiring a recharge of the batteries.

Solutions to the common problems with electric cars and power drainage have been increases in the size of the onboard battery packs, hybrid-mode vehicles that utilize both an internal combustion engine and electrical power in a series or parallel configuration, or gasoline-assisted electric cars that utilize an internal combustion engine as a backup power supply to the batteries when the electric power has been drained while traveling. These devices are all viable options for the range problem of current electric cars; however they do not address the problem of rapid power drainage or utilize all available power sources while the vehicle is driving. The present invention is a device that addresses these issues by offsetting the drainage of battery power while driving an electric vehicle, thereby improving its range.

The present invention utilizes the air flow over the external surface of an electric vehicle, converting the air flow into usable electrical power. It is understood that the laws of thermodynamics and efficiencies of the system limit the amount of power that can be generated. Particularly when comparing the generated energy to the energy expelled to overcome the rolling resistance of the vehicle due to the vehicle weight and friction with the road, the wind resistance due to aerodynamic drag on the vehicle traveling through the air, the internal resistance and efficiency loss of the onboard moving mechanical components, and finally the conversion efficiency of transforming rotating turbine energy into usable electrical power. When analyzing these competing factors and understanding the laws of thermodynamics, it is understood that the system cannot generate enough power to indefinitely power a vehicle, i.e. a perpetual motion machine. The device, rather, is intended as an energy offset device, in which a low profile turbine is utilized to recapture energy expelled to power the vehicle down the road and through the air, reducing the electrical power consumption rate of current electric automobiles.

Several devices have been developed, patented and published in the art for utilizing air flow over a vehicle to generate electrical power. These devices are large in nature, consuming a large amount of area on the vehicle external surfaces, further weighing down the vehicle and drastically increasing aerodynamic drag. They also require extensive modification, or more commonly a specific vehicle design to capture the air flow.

Devices of this type are U.S. Pat. No. 4,179,007 to Howe, wherein a self-propelled vehicle comprises a large wind rotated rotor and flywheel for transforming incoming air flow into electrical power. U.S. Pat. No. 3,894,925 to Stoeckert describes a similar device in which the roof of a vehicle is converted into a large wind turbine platform. Vanes internal to a housing are turned by incoming air flow. U.S. Pat. No. 4,168,759 to Hull similarly describes a full vehicle system that utilizes a specific vehicle body to direct air flow into a roof-mounted inlet, driving an angularly oriented impeller positioned behind the air scoop. U.S. Pat. No. 4,314,160 to Boodman describes an air scoop mounted on a vehicle, in which incoming air spins a turbine for electric power generation. Finally, U.S. Pat. No. Vu describes an energy capturing device for moving vehicles, particularly trucks, in which a wind deflector is utilized to direct air into a turbine for electric power generation.

The aforementioned prior art devices have several known drawbacks. These devices are very large in nature, and are prohibitive on electric cars because of their weight and overall size. The size and weight of an electric vehicle is an important factor to its range, as heavy or highly wind resistant vehicles waste a considerable amount of power when moving the vehicle from rest and at high speeds. The present invention is also highly modular and low profile, allowing the wind turbine and associated inlet to be mounted anywhere on the exterior surface of a vehicle. The invention is particularly useful at high speeds, where aerodynamic drag is very high and the turbine can be spun at very high speeds. In total, the device provides an inflow of electric power to a battery management system to offset the energy usage of an electric vehicle and extend its range between battery recharges.

### SUMMARY OF THE INVENTION

In view of the foregoing disadvantages inherent in the known types of vehicle wind power generation devices now present in the prior art, the present invention provides a new wind power generation device wherein the same can be utilized for providing convenience for the user when offsetting the energy usage in an electric car and extending its range between battery recharges.

It is therefore an object of the present invention to provide a modular wind turbine mountable to a vehicle in several locations along its exterior surface, providing a low profile, low impact device that can recapture energy lost during transit.

Another object of the present invention is to provide an energy offset device that extends the range of an electric vehicle by utilizing external airflow to generate energy that is lost to drag and other sources.

Yet another object of the present invention is to provide a finned wheel turbine blade, encased in an air scoop, to accept incoming air flow and turn an alternator, providing electrical power to a power management system or controller, which in turn can recharge the onboard batteries.

Other objects, features and advantages of the present invention will become apparent from the following detailed description taken in conjunction with the accompanying drawings.

### BRIEF DESCRIPTIONS OF THE DRAWINGS

FIG. 1 shows a typical vehicle installation of the present invention, wherein a low profile scoop is provided on the hood of a vehicle.

FIG. 2 shows a perspective view of the present invention, wherein a wind turbine is encased within a shrouded air scoop, providing rotation to a side-mounted alternator.

### DETAILED DESCRIPTION OF THE INVENTION

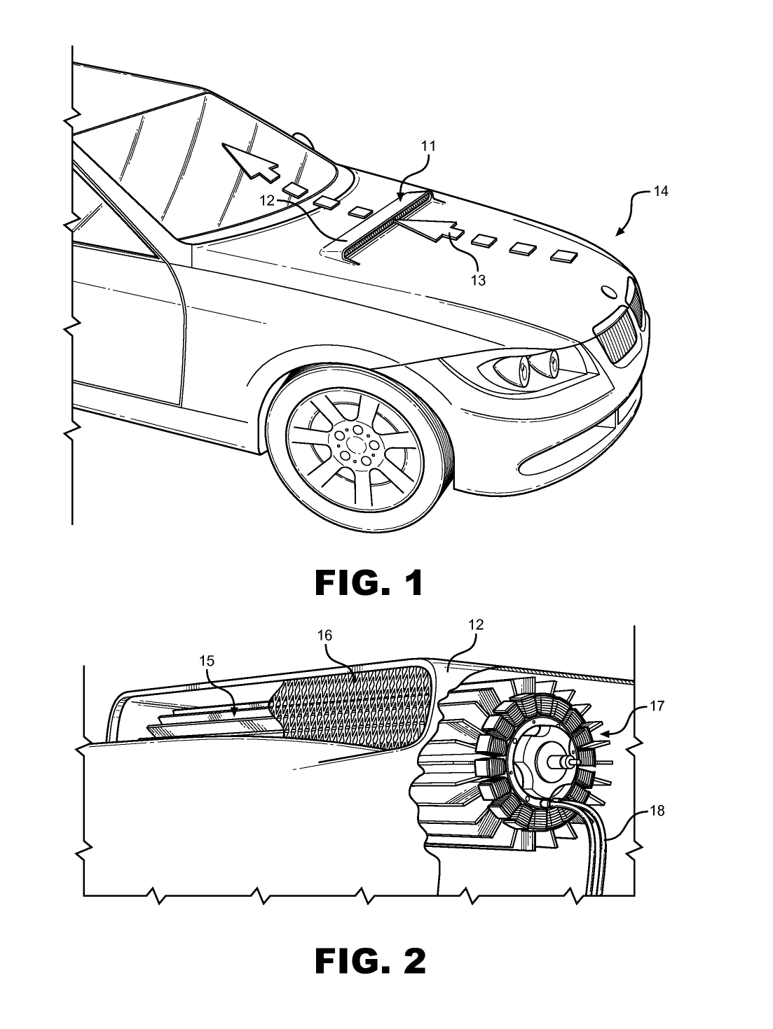

Referring now to FIG. 1, there is shown a hood-mounted installation of the present invention 11. A raised air scoop 12 is placed on the external surface of the vehicle 14 to capture air flow 13. As the vehicle 14 increases in velocity, the air flow into the inlet 12 increases in volume and in velocity. This in turn increases the rotational velocity of a wind turbine housed within the inlet 12 and translates into higher levels of energy generation. The power management system, along with efficiencies of the turbine and alternator have an effect on how much energy can be created with respect to the power of the incoming air flow 13.

Referring now to FIG. 2, there is shown a perspective view of the present invention. A rotatable wind turbine 15 is mounted within a raised air scoop 12. Fins of the wind turbine 15 accept the pressure of the incoming air to provide motive power for its rotation. A mesh screen 16 provides protection for the wind turbine 15 and the rest of the internal structure within the scoop 12 by catching discrete source objects and preventing them from entering the scoop 12. These objects include rocks, bugs and other debris from the road that can interfere with the operation of the present invention. For winter conditions or cold temperatures, an electrical heating source may be supplied to heat the mesh screen and prevent ice and snow buildup, which would block inflowing air into the inlet. Along the back of the scoop 12 is an air outflow vent, allowing air to enter the scoop 12 in the front and escape through its rear.

The turbine 15 is rotatably mounted using a plurality of bearings supporting its central axis. On either end of the turbine 15 is an alternator device 17, which utilizes the rotation of the wind turbine 15 central axis to turn a rotor within a stator device. The relative motion of the rotor and stators produces an electric current, which is fed into a vehicle's power management system via a set of electrical cables 18. The power is then distributed to the vehicle's battery pack or fed directly into an electric motor. The alternator device 17 may be used on one or both sides of the turbine 15.

In use, the present invention is a low profile wind powered device for electric vehicles, and one that provides minimal impact on the baseline design of a vehicle. The scoop may be mounted anywhere along the external surface of a vehicle, including the hood, the roof or the trunk, in a similar style as a raised air spoiler. Ideal locations are those areas that generate the highest levels of air pressure along the vehicle surface, which can be determined using wind tunnel testing or computational methods. The device does not protrude into the internal structure of the vehicle, eliminating costly design changes to incorporate the device. Electric wires are routed into the vehicle to a power management system or directly into an electrical system to provide power to the vehicle's electric motors.

The power generation device is preferably an alternator or stator device, similar to those found on motorcycles and current automobiles. Its volume is a consideration, as the device is not intended to protrude into the vehicle's structure. Alternatively, the power generation means may include a permanent magnet alternator, an induction motor, a DC generator, a brushless DC servo motor, or any other device known to one skilled in the art for generating electrical power from a rotational motion.

In total, the device does not intend to indefinitely power an electric vehicle, but rather provide a means to offset the power consumption rate and extend the range of the vehicle beyond its baseline design. Similar to regenerative braking, the present invention recaptures expelled energy that would otherwise be lost. The energy required to move a vehicle along the road and through the air is considerably higher than what can be supplied by one or a plurality of wind turbines on the vehicle, but there is an amount of recoverable energy that can be placed back into the system to improve energy consumption and relieve range anxiety for consumers. The present invention fulfills these goals and provides a means to generate power using the air flow over a vehicle's external surface.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electric vehicle energy offset device that utilizes air flow over the exterior surface of said vehicle, comprising:
an air scoop with an inlet and an outlet, said inlet facing toward a forward direction of travel of said vehicle, said outlet facing in a opposite direction of travel of said vehicle;
a rotating wind turbine with a plurality of fins, rotatable about a central axis;
an electrical power generating means at a first end of said wind turbine, said power generating means utilizing said rotation about a central axis to generate an electric current;
said electric current is fed to a power management system or to an electric circuit to recharge a battery pack.

2) A device as described in claim 1, wherein said air scoop inlet is shrouded with a mesh screen to prevent discrete source debris from entering.

3) A device as described in claim 1, wherein said electrical power generating means are provided on a first and second ends of said wind turbine.

4) A device as described in claim 1, wherein said energy offset device is mountable to said vehicle hood.

5) A device as described in claim 1, wherein said energy offset device is mountable to said vehicle roof.

6) A device as described in claim 1, wherein said energy offset device is mountable to said vehicle trunk lid.

7) A device as described in claim 1, wherein said electrical power generating means being an alternator.

8) A device as described in claim 1, wherein said mesh screen is heated in cold environments by an electrical heating means to prevent ice and snow build up.

9) An electric vehicle energy offset device that utilizes air flow over the exterior surface of said vehicle, comprising:
an air scoop with an inlet and an outlet, said inlet facing toward a forward direction of travel of said vehicle, said outlet facing in a opposite direction of travel of said vehicle;
a rotating wind turbine with a plurality of fins, rotatable about a central axis;
an alternator at a first end of said wind turbine, said power generating means utilizing said rotation about a central axis to generate an electric current;
said electric current is fed to a power management system or to an electric circuit to recharge a battery pack;
said air scoop inlet is shrouded with a mesh screen to prevent discrete source debris from entering.
